(19) United States
(12) Patent Application Publication
(10) Pub. No.: US 2013/0320686 A1
(43) Pub. Date: Dec. 5, 2013

(54) MAGNETIC LIFTING DEVICE

(71) Applicant: Magswitch Technology, Inc., Westminster, CO (US)

(72) Inventor: David H. MORTON, Boulder, CO (US)

(21) Appl. No.: 13/906,530

(22) Filed: May 31, 2013

Related U.S. Application Data
(60) Provisional application No. 61/665,611, filed on Jun. 28, 2012.

(30) Foreign Application Priority Data
May 31, 2012 (AU) 2012902268

(51) Int. Cl. B66C 1/04

(52) U.S. Cl. CPC B66C 1/04
USPC 294/65.5

(57) ABSTRACT

A magnetic lifter device having a housing with a work piece engagement face. A support structure comprises two clevis-shaped members having, respectively, legs whose terminal ends are hinged to opposite, exterior side faces of the housing at respective fulcrums located close to the engagement face and the clevis-shaped members straddle the housing across a width thereof. The relative positions of the fulcrums and the length of the legs are selected such that at least one of the clevis-shaped members may be rotated away from a first operational position of the lifter device, in which both clevis-shaped members converge to form a common hoop for insertion of a coupling member, into a second operational position, in which the work piece engagement face has been rotated by about 90 degrees from its orientation in the first operational position and its head portion remains clear of the housing during said rotation.

This application claims the benefit of U.S. Provisional Patent Application Ser. No. 61/665,611, filed Jun. 28, 2012, the entirety of which is incorporated by reference herein.

This application also claims the benefit of Australian Provisional Application No. 2012902268, filed May 31, 2012, the entirety of which is incorporated by reference herein.

### FIELD OF THE INVENTION

The present invention relates generally to material handling equipment and in particular to magnetic lifting devices that can be suspended from a crane boom, gantry or other overhead structure used in lifting, handling or conveying ferromagnetic work pieces, such as steel plates, billets, tubes and the like. Whilst a preferred lifting device would use permanent magnets as the sole source of magnetic flux for securing a work piece to a working face of the device, the invention is equally applicable to lifting devices utilizing electromagnets alone or in combination with permanent magnets.

### BACKGROUND TO THE INVENTION

Permanent and/or electromagnetic lifting tools and devices for picking-up all types of ferromagnetic objects, be such planar work pieces like steel sheets or bulky, regularly or irregularly shaped work pieces such as steel pipes, engine blocks, etc, as well as scrap metal, for the purpose of handling and conveying, have been known for many decades in the prior art.

Generally speaking, the make-up of the actual magnetic device or tool which carries the magnetic flux source employed in attaching the ferromagnetic objects to a working face of the device or tool can vary greatly, depending on the type of magnetic flux source employed, eg electromagnets or/and permanent magnets with (or without) soft magnetic pole pieces, the type and complexity of arrangements used for switching the flux source between a state in which the ferromagnetic objects will attach and remain secured to the working face of the device or tool and a state in which the ferromagnetic objects will be released, and the working face geometry required to establish an optimal, preferably air-gap free interface between working face and objects to be magnetically retained at the device or tool, to name but a few factors.

So for example, U.S. Pat. No. 4,802,702 (Bownds) illustrates and describes a magnetic lifting tool for use in clean up and removal of ferromagnetic waste objects from construction sites. The tool comprises an elongate L-shaped handle and a circular lifting plate (consisting of an external, squat-cylindrical housing member of non magnetic material, either a permanent magnet or an electromagnet received within the housing, and a steel alloy cap inter-fitted with the housing and closing the otherwise open lower face of the housing. The housing is attached in fixed manner to a lower terminal end of a tube which is telescopically inserted into and selectively secured onto a leg of the L-shaped handle by way of which a user may hold the device and skim with the lifting plate over a surface for magnetic debris collection. Spatial orientation and attitude of the working face provided by the steel cap member is adjusted by manual movement of the handle to which the lifting plate is attached.

U.S. Pat. No. 4,504,088 (Carter) discloses various embodiments of manually operated lifting tools in which hydraulic or pneumatic pressure is used to cause relative displacement of a non-magnetic contact member which provides a working face of the tool. The contact member can be a thin elastomeric membrane which in use of the tool will be brought in abutting contact with a ferromagnetic object to be manipulated (held, lifted etc); and between proximate and distal positions with respect to an operating face of a permanent magnet received within a non-magnetic housing of the tool. In one embodiment, the housing is in turn provided at an end distal from the working face with attachment means for attaching the lifting device to suitable crane mechanisms or the like, such as an articulated ball-cup joint.

U.S. Pat. No. 5,435,613 (Jung), European patent EP 0974545 (Jung) and US patent publication US 2003/0146633 A1 (Jung) respectively describe and illustrate different permanent magnetic lifting apparatus, all of which comprise multiple permanent magnetic substructures. A number of these substructures in form of magnetic rotors are held rotatable within a housing of the apparatus, and a complimentary number of substructures are fixed within the housing in respective magnetic stator structures. Such arrangement provides a switchable permanent magnet unit or device which may be turned on and off by rotation of the magnetic rotors with respect to the stator structures. Defined rotational positions of the rotor structures cause magnetic flux to become available in creating a closed magnetic circuit when a working face of the apparatus is brought into contact with a ferromagnetic work piece (such as a steel plate). The working face is provided at free terminal surfaces of magnetisable, soft iron pole plates secured within and forming part of the housing, and which are in gap-free contact with the permanent magnets of respectively adjoining stator structures.

In contrast, U.S. Pat. No. 4,314,219 (Haraguchi) and U.S. Pat. No. 5,382,935 (Doyelle), although respectively embodying structurally different magnetic lifting apparatus, rely on the same principle of arranging all magnetic active mass present in the apparatus in one or more rotor structures which additionally comprise two soft-iron bodies that are respectively oppositely polarised by the permanent magnets (ie the magnetic active mass). The rotor structure(s) is (are) received between soft-iron pole plates or members that are magnetically isolated from one another and which provide at respective free terminal edge surfaces the working or engagement surface of the lifting apparatus that can be brought into contact with a ferromagnetic work piece to be held and manipulated (eg lifted or moved). The rotational position of the rotor pole pieces with respect to the facing pole plates will determine whether or not magnetic flux may flow from the permanent magnets through the rotor pole pieces into the stationary pole plates and from there into the work piece. In effect, the pole pieces of the rotor member(s) provide passive magnetic ‘shunting’ bridges when positioned to face the oppositely located pole plates between which the rotor(s) is (are) sandwiched.

One common feature of the lifter apparatus/devices of Jung, Doyelle and Haraguchi is the provision of a handle or actuator member, suitably journalled or otherwise supported at the device housing and linked with the rotor(s), which in the case of Haraguchi is effected through an appropriate gear system to effect synchronised rotation of the multiple magnetic active rotors of the apparatus, for rotating the rotors between ‘on’ and ‘off’ positions of the apparatus/device.

Another common feature is the presence of a bull ring or u-shaped eye hook on an upper exterior part of the device housing, by way of which the devices can be coupled to a cable, chain or other type of support member suspended from a crane, gantry or other overhead structure used in bringing the magnetic lifter device/apparatus in contact with (and removed from) a ferromagnetic work piece to be secured to and lifted with the device. It is noted that the rings and hooks are fixed orientationally with respect to the housing. That is, the freedom of movement of the lifting devices at the cable or chain is dictated solely by the type of counter member or connection structure used to suspend such lifter devices from the cable or chain. Such counter member may be either a simple c-shaped hook or a U-shackle fixed in known manner to the cable or terminal chain link, or a noose at the end of the cable or rope used to lift the lifter device/apparatus.

In contrast to such type of spatially fixed supporting structure/member at the magnetic lifter device/apparatus, which may also be referred to as a magnetic lifter head, U.S. Pat. No. 3,389,356 (Schneider) discloses a magnetic lifter which employs a u-shaped clevis with legs pivoted (ie hinged) to respective connector plates that extend upwards from a top plate of the device's housing. Consequently, the clevis provides a handle or support member hinged at the device housing, which provides greater degree of freedom of movement of the device housing with respect to the supporting cable or chain from which the housing can be suspended for magnetic hoisting operations of a work piece.

As regards possible other types of support and connection structures and arrangements that may be employed in a magnetic lifter device of the types above described, U.S. Pat. No. 3,298,730 (Soley) discloses an electro magnet lifting device having a squat hollow cylindrical housing having a circular top plate and cylindrical skirt. Four lug flanges protrude upwards from the top plate in equilateral spacing in a symmetrical arrangement with respect to a central axis of the device which extends normal to the top plate plane. The lug flanges form integral part of four pole pieces that provide at a lower terminal end thereof the work piece engagement surfaces (ie the working face) of the lifter and about which coil bundles of respective electromagnets are carried.

The lug flanges serve as pivot anchor points for terminal links of four support chains by way of which the lifter can be suspended from a crane boom or the like. The apertures in the top plate through which the lug flanges extend and which serve to fix the position of the pole shoes at the top plate, and the lug flanges themselves are dimensioned to allow little or no play in order to minimise flexing between these parts when the lifter is carrying load, and are positioned relative to the central axis of the lifter in such a way that shock loads or blows with a load attached to the lifter will be resisted. In effect, a connection structure that is semi-rigid against lateral displacement is provided between lifter housing and the four chain members converging upwardly to a common support point at a crane hook or similar connection member carried at the end of the otherwise flexible cable used for lifting the lifter when under load. The overall structure is, partly due to the required manufacturing tolerances of all components that form part of it, unnecessarily complex and expensive.

A resilient support structure between a lifter device and the cable, rope or chain support means used to suspend and support a magnetic lifter device from a crane boom or the like is disclosed in U.S. Pat. No. 3,471,193 (Hayes). Three double-wing pedestal flanges (or clevises) are provided on the upper side of the top plate of the squat cylindrical housing of the magnetic lifting device, located at apices of an equilateral triangle adjacent the peripheral wall of the housing. A telescopic piston—cylinder tube unit with internal spring serves to bias a base plate with bull ring structure away from the top plate, which structure is otherwise connected to the top plate via three lift chains whose opposite terminal links are pivoted at the clevises and via bolts to the base plate, respectively. The lift chains are maintained taut by the spring action so that the bull ring may be easily engaged by a crane hook solely by manipulation of a crane lift block and the hook by a crane operator. Again, a semi-rigid but sufficiently elastic connector support structure is provided.

As will be appreciated from the above summarised documents, either individually or in combination, there are a number of drawbacks in particular with the support structures by way of which the lifting device is suspended from and supported by the lifting and support cable (or similar, flexible tensile support member) carried by a crane boom or similar overhead support structure.

Relevantly, whilst it is not uncommon to transport ferromagnetic plates of varying thicknesses and dimensions in a horizontal positional attitude, manual intervention will be required to tilt such plates into a vertical positional attitude for upright storage on an edge of the plate. To this end, after initial transport, the lifter head must be disengaged or otherwise moved from a general centre of gravity indicative position at the plate, required for horizontal transport of the plate, towards an edge opposite to that on which the plate is to be tilted for upright storage.

In this context it is relevant in that the support structures are conceived with an aim of maintaining the working (or attachment) face of the lifter head in a generally horizontal attitude, thereby to maintain the suspended plate in horizontal attitude too, and minimise shear loads that would arise at the interface between work piece and lifter device working face due to misalignment of the device's main normal (vertical) axis, when suspended from its carrying cable, and the centre of gravity (CG) axis of the object to be lifted. Unwanted bending moments will result in some of the components of the support structure, such as eg in the telescopic guiding piston-cylinder unit of the Hayes lifter, or result in undesired load redistribution onto one or two of the flexible tensile members in the support structure of the lifting device, when the load is suspended with its CG distal from the location where the lifter attaches to the load.

Such load redistributions and damaging bending moments are minimised in support structures such as single bull loop or devises (as used in the Jung and Carter lifting devices), however, these have the disadvantage of allowing greater swaying of the suspended load and lifter head at the end of the lifting cable or chain.

### SUMMARY OF THE INVENTION

Having regard to the above, it is one aim of the present invention to provide an improved support structure for use with magnetic lifter devices adapted to be hoisted by means of cables, ropes, chains or similar flexible tensile members suspended from and supported by crane boom arms, gantries or similar overhead hoisting machine components, which can be engaged by a simple crane hook to hoist the lifter device and nonetheless provide greater positional and orientational stability of the suspended lifter device when under load at such hook.

It is another object of the invention to provide an embodiment of such support structure which will allow versatility in magnetic lifter work piece transportation in that it should allow hoisting and transport of a ferromagnetic plate in horizontal, inclined or vertical orientation without introducing unwanted load distribution and exertion on components of the structure, in particular arising from misalignment of the CG of the work piece with a lifting axis of the magnetic lifting device that extends normal to its work piece engagement surface (working face) or the CG of the lifting device along a common lifting direction.

It is another object to provide a magnetic lifting device, in particular a lifting device using exclusively permanent magnets, which provides constructional ease in incorporating such improved support and hoisting structure.

Other aims and objects will become apparent from the ensuing description.

In accordance with a broad aspect of the invention there is provided a magnetic lifting device, having: a housing; at least one switchable magnet arrangement comprising preferably exclusively permanent magnets, received at the housing, which is adapted to deliver magnetic flux to a work piece engagement face of the device carried by the housing; an actuation mechanism carried at the housing and arranged for switching the switchable magnet arrangement between switching states in which magnetic flux is made available at or is absent from the engagement face; and a support structure mounted to the housing and arranged for releasable engagement with a coupling member carried at tensile load carrying means suspended from and supported at an overhead load carrying member of a crane, gantry or similar lifting and conveying apparatus, characterised in that the support structure is comprised of two clevis-shaped members having, respectively, legs whose terminal ends are hinged to opposite, exterior side faces of the housing at respective fulcrums located preferentially close to the engagement face and such that the clevis-shaped members straddle the housing across a width thereof, and in that the relative positions of the fulcrums at the housing and the length of the legs are selected such that at least one of the clevis-shaped members may be rotated away from a first operational position of the lifting device in which head portions of both clevis-shaped members converge on one another thereby forming a common hoop into which may be inserted the coupling member, into a second operational position of the lifting device in which the work piece engagement face has been rotated by about 90 degrees from its orientation in the first operational position and its head portion remains clear of the housing during said rotation.

The first aspect of the invention has been described partly in functional terms as the specific geometry and external shape of the housing will influence the specific location of the fulcrums and dimensions of the clevis-shaped members. Relevant in the context of the invention is that at least one of the clevis-shaped members may be rotated with respect to the housing from a first position in which the head portion locates with sufficient clearance above a top face of the housing (using a horizontal plane as reference), into a second position wherein the legs of the clevis-shaped member will extend approximately parallel to the horizontal reference plane and the head portion will remain clear from the housing.

The layout is thus one which enables the lifting device to hoist a plate in horizontal as well as vertical orientation, in that horizontal lifting and transport will be effected with the lifting device suspended from both clevis-shaped members, preferably using a single hoisting cable, chain or the like, whereas vertical hoisting and transport will see the device being suspended using one only of the clevis-shaped members and the device housing being in a rotationally offset position with its work piece engagement face firmly magnetically attached to the plate.

A preferred (although not essential) consideration in the lay out is to have the fulcrums of the two clevis-shaped members located in a common plane that extends with as short as possible distance from a plane defined by the engagement or working face of the lifting device. The centre of gravity (CG) of the lifting device should preferably also locate as close as possible to the common plane. Such preferred arrangement aims to minimise induced moments that will result from a misalignment of an axis extending through the CG of a ferromagnetic plate when suspended from the lifting head in a generally upright orientation (in which the lifting device will be suspended from one only of the clevis-shaped members and the latter is in the second operational position) and the CG of the lifting device with respect to a vertical plane comprising the gravity vector.

In use of the device, with a ferromagnetic plate supported at the engagement face such that the CG of the plate is advantageously located within the footprint area of the engagement face, the lifting device can be suspended from a lifting cable connection member (eg a hook) via the head portions of both clevis-shaped members (the housing would be in the first operational position), thus providing a quasi stable horizontal transport position for the plate. Directionally uncontrolled sway movements are supressed to greater extent, and sew-saw movements of the suspended load can be more readily controlled or supressed by the operator of the crane (or similar hoisting apparatus) from which the lifting device is suspended in use.

In one embodiment, the housing is box shaped, wherein a lower side thereof provides the working face, which preferably is provided with exchangeable pole shoe plate members to minimise contact wear at the housing proper. The plate shoe members may be appropriately shaped to manipulate magnetic flux passage into the work piece from the flux source at the lifting device, also in seeking to optimise magnetic adhesion of the work piece at the lifting device and/or provide a work piece engagement surface that is at least partially contoured to match the (partially or fully) the shape of the ferromagnetic object to be lifted.

Furthermore, locating members can advantageously be provided at the housing which can be selectively moved between a locking and an unlocked position and which are spatially located such as to selectively fix the relative rotational positions of the clevis-shaped support members with respect to the housing in the first and second operational positions of the lifting device. In one embodiment, the locating members are simple stop pins or bolts that are received in suitable bores of the housing.

The above and other objects and further scope of applicability of the present invention, in its different embodiments, will become apparent from the detailed description of preferred embodiments that follows below. However, it should be understood that the detailed description and illustrated embodiments of the invention in the accompanying drawings are not exhaustive and limiting, since variations and modification that do not depart from the broad inventive concept identified in the claims, and which will become apparent to the skilled reader in the art of the present invention, are possible.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a side perspective view of a magnetic lifting device in accordance with and incorporating an embodiment of a hoisting support structure in accordance with a first embodiment of the present invention;

FIG. 2 is a side plan view of the device of FIG. 1 shown in an intermediate orientational attitude achieved during lifting of a plate-like ferromagnetic work piece when the latter is attached to the lifting device with the CG of the plate off-set from the CG of the lifting device;

FIG. 3 is a further side plan view of the device of FIG. 1 shown in a final, vertical orientational attitude for lifting of the plate-like ferromagnetic work piece in a vertical orientation; and

FIG. 4 is a perspective, exploded view of the lifting device of FIGS. 1 to 3, showing its components in a disassembled state.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

In using terms such as upper, lower, longitudinal, width, horizontal, vertical and similar relative terms in the following description, it will be appreciated that such is done to facilitate understanding of relational arrangement and orientation of component parts and features of the lifting device described herein, also in use. Unless dictated otherwise from the context of use of such terms, there is no intention for such terms to impart a limitation on features to which such relate.

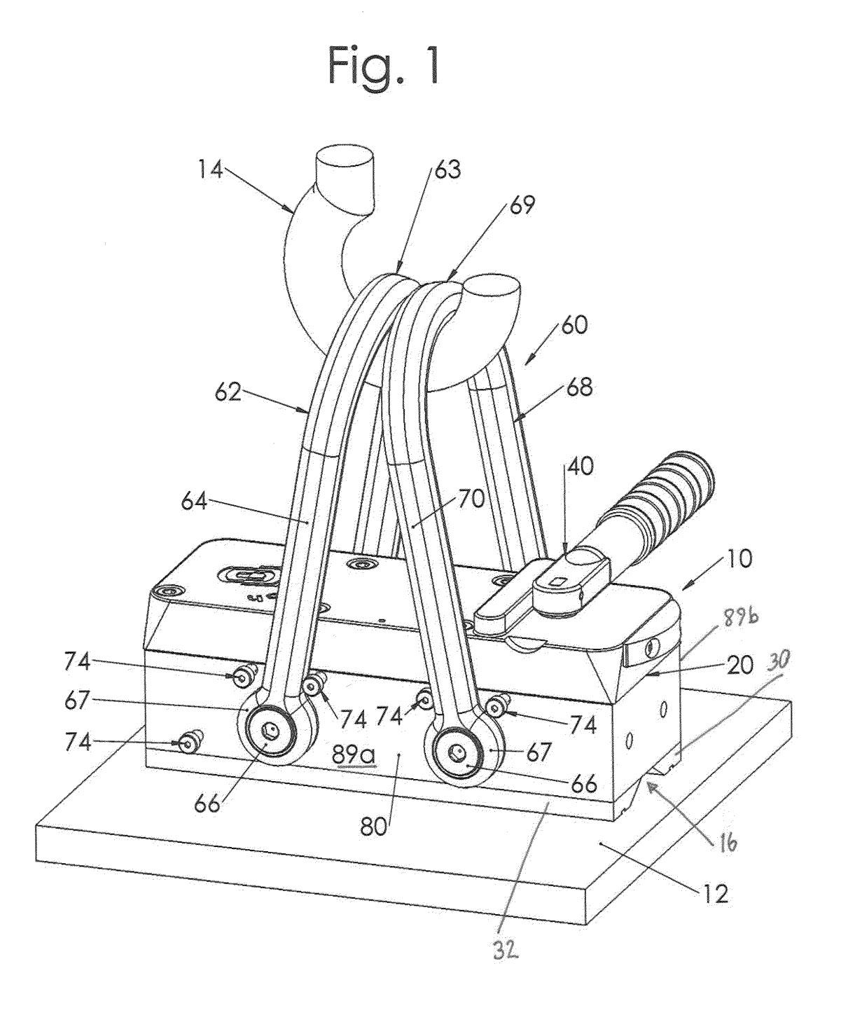

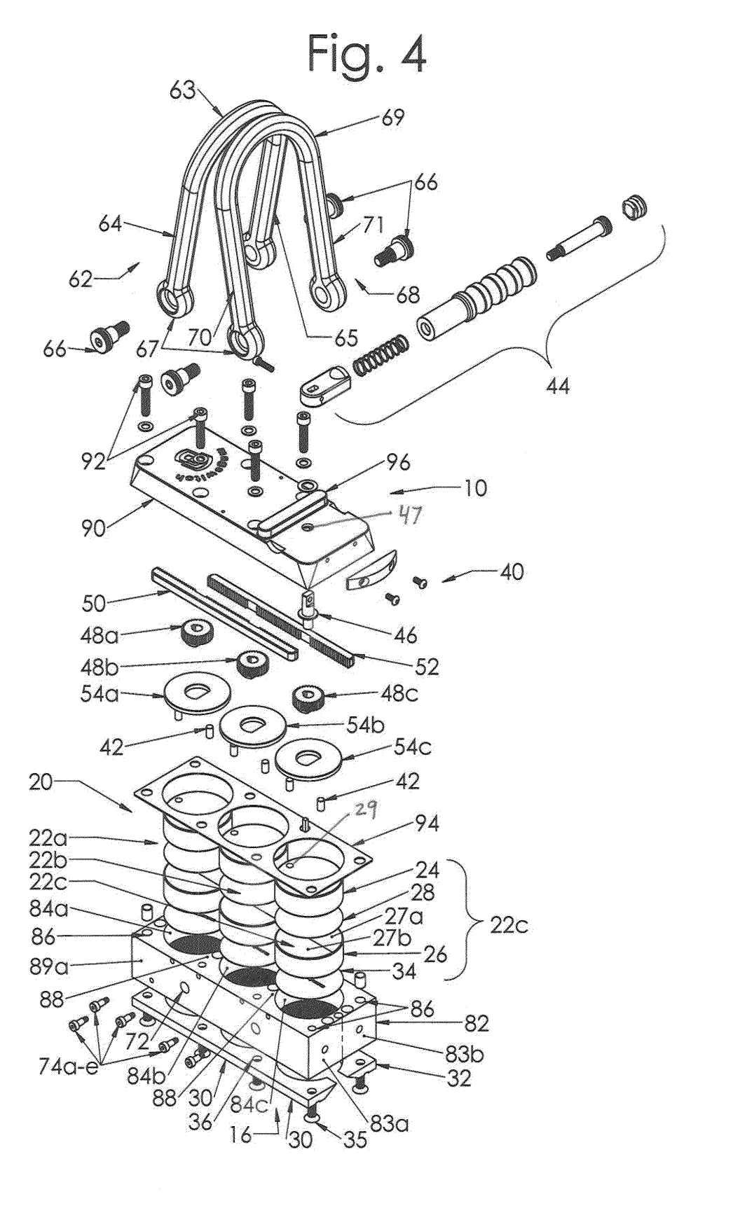

Turning first to FIGS. 1 and 4, there is illustrated a preferred embodiment of a magnetic lifting device 10 (also referred to as magnetic lifter) in accordance with the present invention. It comprises four functional units or subgroups, namely: a switchable magnetic flux delivery subgroup 20 comprising three identical permanent magnetic units 22ra-c and two pole shoes 30, 32; an actuator subassembly 40 for switching the magnetic flux delivery subgroup 20 between ‘on’ and ‘off’ states of device 10; a support structure 60 by means of which lifting device 10 can be suspended from and supported at a c-hook 14 or similar coupling element carried at the end of a hoisting cable (not shown) of a crane, gantry or other type of overhead lifting apparatus, in two distinct lifting attitudes; and a two part housing 80 in which are received, mounted and otherwise carried all of the afore mentioned subgroups.

Such lifter device 10 can be used to magnetically secure a ferromagnetic object to it, and to this end magnetic flux delivery subgroup 20 is switchable by actuator subassembly 40 between a state in which no magnetic flux is available for ‘use’ at the pole shoes 24, 26 and a state in which such magnetic flux is available and useable for attaching a ferromagnetic work piece, such as embodied in a steel plate 12 in FIG. 1, to a work piece attachment face 16 of device 10, provided by pole shoes 24, 26, by creating a closed magnetic circuit comprising the magnetic units 22, passive pole elements at the housing (as will be described), the pole shoes 24, 26 and the work piece, as is well understood in the art of magnetic lifting devices.

Housing 80 is comprised of a lower housing block 82 made from magnetisable ferromagnetic material, which is rectangular parallelepiped (or brick-like) in external shape and has three identical bores 84 extending through a hight of the block 82 between upper and lower faces thereof. Bores 84a-c are arranged in contiguous line in longitudinal direction of housing block 82 and adjoining bores are separated by a relatively narrow web 88 of housing material. It will be further noted that a plurality of holes 86 of varying diameter are present in the width-wise extending web portions 88 so as to also extend between the upper and lower faces of block 82. These serve the purpose of magnetically separating or isolating from one another two zones of lower housing block 82 either side of its longitudinal symmetry plane so as to define albeit not perfectly but substantially magnetically isolated passive pole pieces 83a and 83b integral of the housing 80.

Turning next to the permanent magnetic units 22 of flux delivery subgroup 20, each such ‘unit’ is comprised of two cylindrical, diametrically polarised, rare-earth permanent dipole magnets 24, 26 of almost identical diameter, stacked on one another with a circular, friction reducing but otherwise non-magnetic very thin separator sheet 28 sandwiched between opposing circular end faces of magnets 24, 26.

Each such unit 22 is received in a respective one of said bores 84 in lower housing block 82, whereby it will be noted that lower magnet 26 in each case has a diameter to ensure a tight fit so as to prevent rotation within bore 84a-c; additional or other constructional measures may be implemented for securing lower magnets 26 against rotation in bores 84a-c, as would be known to the skilled person. Lower magnets 26 are furthermore received in bores 84a-c such that the diameter line which separate the N- from the S-poles of each diametrically polarized lower magnet 26 align coaxially with one another, ie come to lie in the longitudinal symmetry plane of block 82. It will consequently also be noted that the polarity of the oppositely magentised segments (or active N- and S-poles) 27a and 27b of lower magnet 26 will be imparted onto the respectively adjoining passive pole pieces 83a and 83b provided by lower housing block 82, which are magnetically separated by bores 86 as was noted above. The lower openings of bores 84 are furthermore sealed off preferably flush with the lower face of block 82 by appropriately dimensioned, thin shunt disks 34 of a suitable material with high magnetic reluctance to also prevent ingress of contaminants and flux leakage paths.

The diameter of upper magnets 24 is slightly smaller than that of bores 84 (but the active magnetic mass preferably the same as lower magnets 26) so that when received therein are free to rotate. It will be further noted that the upper circular face of each upper magnet 24 is provided with two, diametrically oppositely located sink holes 29 which are dimensioned to receive with interference fit respective dowel pins 42 that form part of the actuator subassembly 40 as will be described below and by way of which torque may be applied to upper cylindrical magnets 24 in order to rotate same.

The three neighbouring permanent magnetic units 22, with the functionally and spatially associated passive pole pieces 83a and 83b provided by lower housing block 82 in essence represent three contiguously arranged switchable permanent magnetic devices as described and illustrated in U.S. Pat. No. 7,012,492 (Underwood et all) assigned to Magswitch Worldwide Pty Ltd. The content and disclosure of that document is herein incorporated by way of specific cross-reference to it, and reference should be had to it if the skilled person fails to appreciate the working principle of the units 22 employed in the present lifting device.

In short, rotation of upper magnet 24 relative to lower magnet 26 causes sinusoidal variation of an external magnetic filed created by the superposition of the respective magnetic fields of the individual cylindrical magnets 24, 26 between two extreme values. In an ‘off’ state of each unit 22, upper magnet 24 is positioned such that its north pole 25a substantially overlies the south pole 27b of lower magnet 26. Similarly, it follows that the south pole 25b of upper magnet substantially overlies the north pole 27a of lower magnet 26. In this arrangement, upper and lower magnets 24, 26 act as an internal active magnetic shunt and as a result the external magnetic field strength from each unit 22 is quite low (ideally zero where both magnets have exactly the same mass of active magnetic material and are magnetized identically). Rotating the upper magnet 24 by 180 degrees about its axis of rotation brings unit 22 into an ‘on’ position, wherein the respective north and south poles 25a and 25b of the upper magnet 24 substantially overlie respective north and south poles 27a and 27b of lower magnet 26. In this alignment, the external magnet field from each unit 22 is quite strong (superposition of equally directed magnetic fields) and ferromagnetic materials can firmly attach across the passive pole pieces 23a and 23b associated with the magnets 24, 26 which provide a low reluctance path for flux transfer between magnets and work piece, whereby a closed magnetic circuit is created.

It was noted above that two pole shoes 30, 32 (of passive ferromagnetic material, high abrasive resistance and ideally of very high magnetic permeability) form part of the switchable magnetic flux delivery subgroup 20 which also comprises the three identical permanent magnetic units 22. As perhaps best seen in FIG. 4, the pole shoes 30, 32 are of flat strip-like configuration with three semi-circular cut outs along one longitudinal edge that coincide with the openings of bores 84 when secured to the lower face 81 of lower housing block 82 using appropriately dimensioned flat head steel bolts 35. These bolts are received in threaded counter bores in the lower face of lower housing block 82 and the flat heads are received flush in counter sunk through holes 36 of shoes 30, 32. A total of four bolts 35 per shoe 30, 32 ensure secure attachment of these components to the lower face 81 of block 82. It will be noted that the shoes 30, 32 in effect extend downward the respective passive pole piece 83a and 83b provided by lower housing block 32 thereby to provide a contoured work piece attachment face 16 of device 10.

The presence of removable pole shoes 30, 32 is a desirable but optional feature. They provide exchangeable wear components, as these are the interface and work piece attachment components of the lifter. Furthermore, they may be shaped to provide added magnetic functionality by incorporating shape aspects not only directed to flux shaping to optimise attractive magnetomotive force being exerted on a work piece, but also an engagement face shape that may be formed to at least more closely match the surface contour of a work piece other than a flat plate.

The actuator subassembly 40 employed for synchronised operation (rotation) of the individual permanent magnetic units 22 is mostly housed within and mounted to an upper housing block 90 (or header block) which in plan view is dimensioned to match lower housing block 82 and which is secured thereto using five hexagon socket bolts 92 as typically employed in automotive engine applications, with an intermediary gasket 94. A stop bar 96 is integrally formed on an upper external face of header block 90, its function being to provide a defined stop for a multi-piece, torque sensitive actuator handle 44. Handle 44 protrudes sideways horizontally from housing 80 and is removably connected at one terminal end thorough a biscuit (or other type of form fitting) joint or coupling to the upper end of an actuator shaft 46 which protrudes through an appropriately dimensioned through hole 47 in an upper wall section of header block 90. In turn, actuator shaft 46 is secured in releasable manner inside header block 90 to be rotatable about a vertical axis, but secured against axial displacement.

A lower end of actuator shaft 46 is shaped with form elements which provide a form/shape fit between shaft 46 and a first pinion gear 48a of a rack and pinion transmission thereby to enable torque transfer from handle 44 upon its rotational displacement into pinion gear 48a.

From FIG. 4 it will be noted that there are 3 identical pinion gears 48a to 48c, one associated with each permanent magnetic unit 22a-c. All gears 48a to 48c are disposed to mesh with and between two parallel disposed toothed rack bars 50, 52 received for reciprocating travel in longitudinal direction of housing 80 within appropriately dimensioned channels or grooves formed on an inner side of header block 90. Such rack and pinion step-up transmission gears are well known to the skilled person in kinematics and will not be described here in further detail.

The lower hubs of pinion gears 48a to 48c have an irregular outer cross-section which is form-matched (indexed) to an opening present in respectively associated coupling discs 54a to 54c arranged to rotate with the pinion gears 48a to 48c. Whilst not illustrated, the skilled person will appreciate that the bottom-facing sides of coupling discs 54a to 54c must have receptacle bores or other structures to form fittingly engage with and/or cooperate with the dowel pins 42 present at the upper magnets 26 of units 22 thereby to enable torque transfer from actuator handle 44 via the pinion gears of step-up rack and pinion transmission. The transmission ratio can be chosen to suit, but for safety reasons it is preferred to choose such that a 90 degree turn of handle 44 results in a 180 degree rotation of upper magnets 24 of permanent magnet units 22 in order to switch these from an off state into an on state, as explained above. The visual switching state indication provided by the clearly discernable handle positions should assist in preventing unintended switching off of lifting device 10 whilst a load is suspended from it, as illustrated in FIGS. 1 to 3 exemplarily.

It will be nonetheless appreciated that other types of actuator subassemblies may be used in order to switch the units 22 of magnetic flux delivery sub group 20. For example, instead of manual actuation via handle 44, servo motors, driven electrically, pneumatically or hydraulically may be employed to impart torque onto actuator shaft 46. Furthermore, additional safety elements may be present to prevent inappropriate or accidental operation of handle 44, such as displaceable stop blocks and the like.

As was noted elsewhere, it is desired to provide a support structure 60 which is able to impart some degree of additional stability and sway dampening characteristics onto the lifting device 10 when suspended and secured to an overhead cable or chain, whilst equally providing for operational versatility.

To this end, in accordance with a preferred embodiment, the support structure 60 will essentially consist of two identical clevis-shaped members 62, 68 (which may also be characterised as two substantially U-shaped lifting lugs) having, respectively, an upper bent (or head) portion 63, 69 and two side legs 64, 65; 70, 71 with enlarged, hub-like terminal eye ends 67 in which are received respective shoulder screws 66 for fastening the clevis members 62, 68 to the housing 80 in articulated (hinged) manner, as can be seen from FIGS. 1 to 3 and in particular. That is, the terminal leg ends 67 of clevis members 62, 68 are hinged to opposite, exterior side faces 89a, 89b of lower housing block 82 via the shoulder screws 66 which are screwed into respective sack holes in the side faces, whereby these are located relatively close to lower terminal face 81 of block 80 in a common plane that extends parallel to that the lower end face 81.

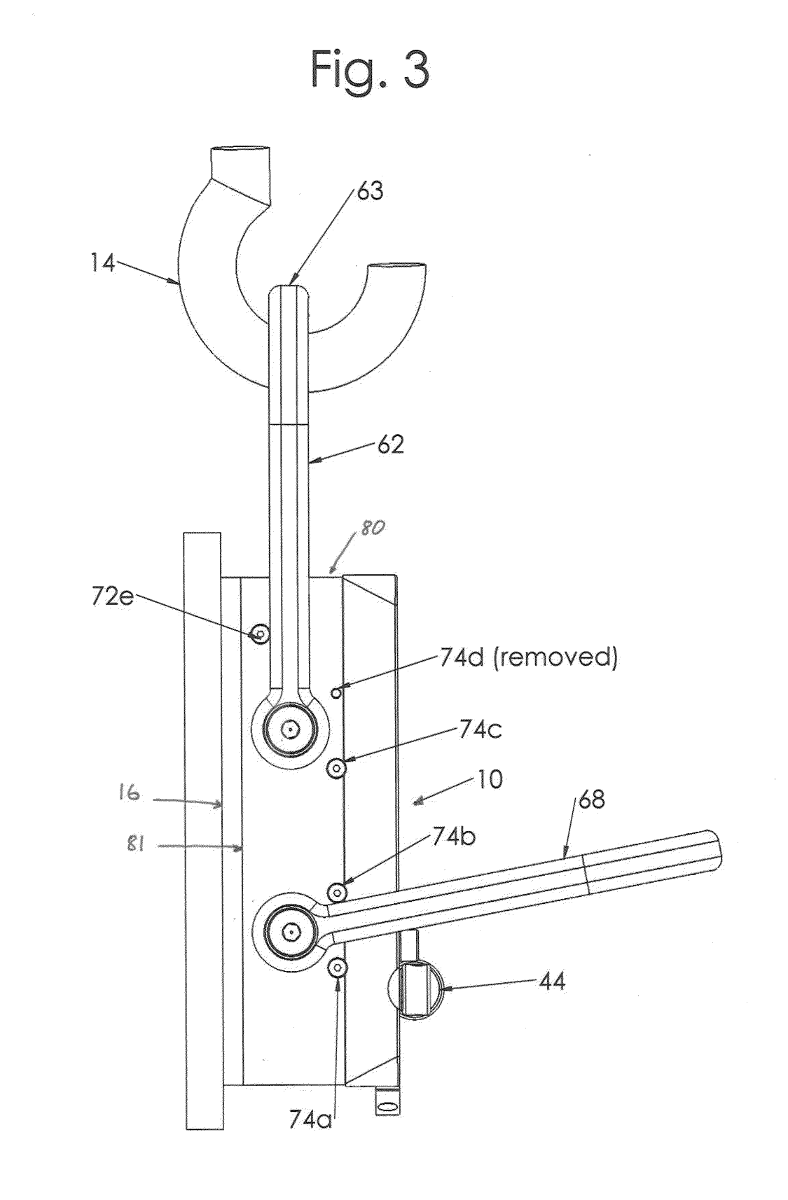

The screws 66 provide fulcrums for rotation of clevis-shaped members 62, 68 relative to housing 80, whereby it is noted that the length of legs 64, 65; 70, 71 is chosen such that lifting lugs 62, 68 can be rotated from a position, as shown in FIG. 1 in which the head portions 63, 69 abut one another and the legs include an acute angle (ie are oriented off-set from the vertical axis), into a position in which the legs 64, 65; extend in the plane comprising the fulcrums, ie in a horizontal plane parallel to lower face 81, as per FIG. 3. In effect, clevis-shaped members 62, 68 straddle the housing 80 across a width thereof and can be rotated into different rotational orientations with respect to lower face 81 of housing 80.

From the figures it will further be noted that a total of five locating screws 74a-74e are provided at each side face 89a, 89b of housing 80, which can be selectively screwed in or out between a locking and an unlocked position and which are spatially located such as to permit selective fixing of the relative rotational positions of clevis-shaped support members 62, 68 with respect to the housing 80 in the first and second operational positions of the lifting device illustrated in FIG. 1 and FIG. 3, respectively. The spacing between cooperating screw pairs 74a-74b; 74c-74d; and 74d-74e to effect the locating/fixing function is such as to allow a certain degree of play or movement of clevis members 62, 68 and provide some ‘elasticity’ under loads, ie avoid a fully rigid support structure 60. In particular the spacing between locating bolts 74d and 74e which restrict the rotation freedom of clevis member 62 when in a position towards parallel with the lower face of housing 80 is chosen such that when a steel plate (or other object) is to be hauled or lifted in an vertical or upright orientation, as shown in FIG. 3, and gravitational forces cause the arms of clevis support member 62 to tilt into vertical under load, the housing 80 will be able to rotate into a slightly inclined position to accommodate for non-alignment of the CG of the lifting device 10 and the CG of the work piece 12 along a common vertical line.

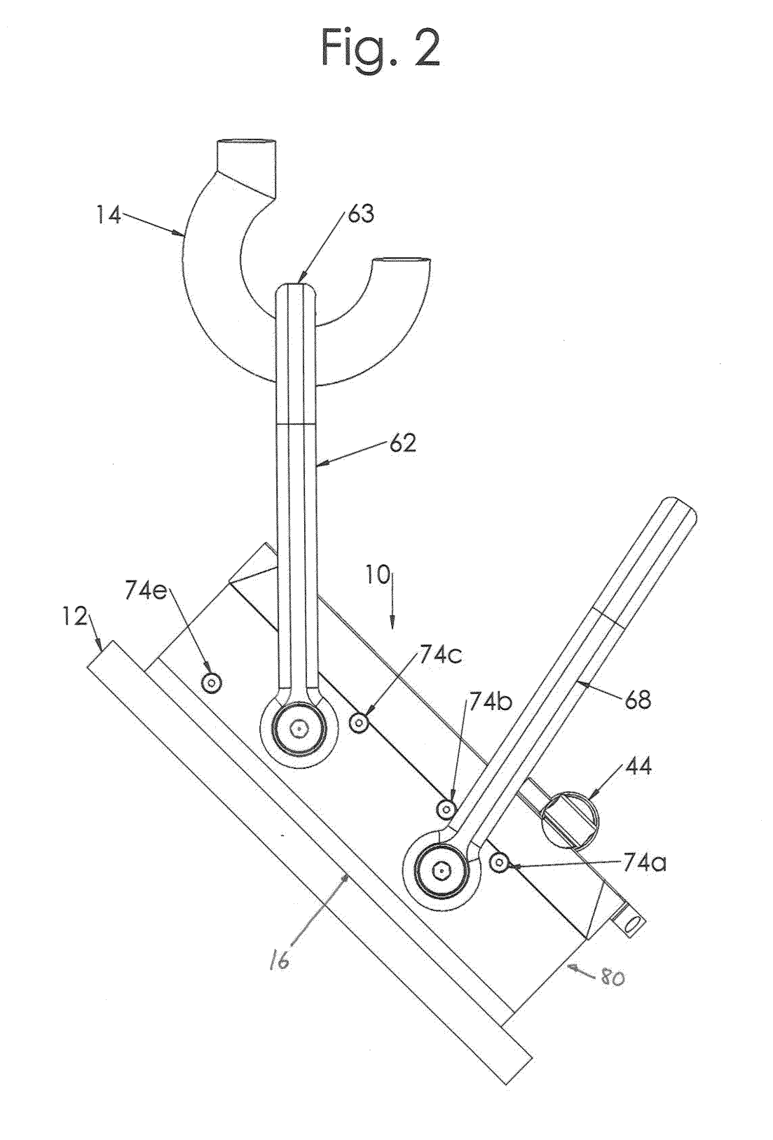

The layout is thus one which enables the lifting device 10 to hoist a plate 12 in horizontal as well as vertical orientation, as shown in FIGS. 1 and 3, in that horizontal lifting and transport will be effected with the lifting device 10 suspended from both clevis-shaped members 62, 68, preferably using a single hoisting cable, chain or the like, whereby a c- or u-shaped hook 14 will simultaneously engage both head portions 63, 69 of clevis shaped support members, whereas vertical hoisting and transport will see the device 10 suspended using one only of the clevis-shaped members (member 62 in FIG. 3) with the device housing 80 being in a rotationally offset position with its work piece engagement face firmly magnetically attached to the plate. FIG. 2 furthermore shows that by locating lifter housing 80 off-set to the CG of a plate-like work piece, preferably close to its edge, it is possible to use the lifting device 10 also as a tool for uprighting plates from a generally horizontal into a vertical position in simple manner, whereby lifting is initiated using only clevis member 62 and as the work piece is raised, moment forces rotated form an initial horizontal orientation into an upright orientation. The freedom of rotation which clevis member 62 has with respect to lifter housing 80 as consequence of the non-fixed attachment of clevis member 62 to lower housing 82 ensures that no pry moment between housing and work piece will arise, which will tend to dislodge the work piece from the working face 16 of the lifting device 10. This has the further advantage that the magnetic units 22a-c can be rated for lower carrying capacity (and thus be smaller in dimensions) as no need arises to provide added magnetic coupling force to counter prying.

As noted, a preferred (although not essential) consideration in the overall lay out is to have the fulcrums of the two clevis-shaped members 62, 68 located in a common plane that extends with as short as possible distance from a plane defined by the engagement face of the lifting device. The centre of gravity of the lifting device should preferably also locate as close as possible to, ideally within the common plane. Such preferred arrangement aims to minimise induced moments that will result from a misalignment of an axis extending through the CG of a ferromagnetic plate when suspended from the lifting head in a generally upright orientation (in which the lifting device will be suspended from one only of the clevis-shaped members and the latter is in the second operational position) and the CG of the lifting device with respect to a vertical plane comprising the gravity vector.

The skilled person will also appreciate that whilst the lifting device 10 illustrated in the figures utilises three permanent magnetic units 22a-c as the magnetic flux source, a smaller or larger number of such units can be employed and the housing and actuation mechanism to switch the device would be modified accordingly.

The applicant has manufactured lifting devices embodying the above principles with varying numbers of switchable magnetic units 22, wherein breakaway loads of 1000-2500 kg have been measured, providing safe lifting of ferromagnetic objects of up to 700 kg (in case of a plate having a thickness of ¼ inch: 273 kg), the weight of the device being between 8-15 kg and with housing dimensions of 260×350×150 mm (approx).

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

1. Magnetic lifter device, comprising:
a housing;
at least one switchable magnet arrangement received at the housing and adapted to deliver magnetic flux to a work piece engagement face of the device;
an actuation mechanism carried at the housing and arranged for switching the magnet arrangement between switching states in which magnetic flux is made available at or is absent from the engagement face;
a support structure mounted to the housing and arranged for releasable engagement with a coupling member carried at tensile load carrying means suspended from and supported at an overhead load carrying member of a crane, gantry or similar lifting and conveying apparatus;
wherein the support structure comprises two clevis-shaped members having, respectively, legs whose terminal ends are hinged to opposite, exterior side faces of the housing at respective fulcrums and such that the clevis-shaped members straddle the housing across a width thereof; and
wherein the relative positions of the fulcrums at the housing and the length of the legs are selected such that at least one of the clevis-shaped members may be rotated away from a first operational position of the lifter device, in which head portion of the clevis-shaped members converge on one another thereby forming a hoop into which may be inserted the coupling member, into a second operational position of the device in which the work piece engagement face has been rotated by about 90 degrees from its orientation in the first operational position and its head portion remains clear of the housing during said rotation.

2. Lifting device according to claim 1, wherein the switchable magnet arrangement comprises one but preferably a plurality of permanent magnet units received within the housing.

3. Lifting device according to claim 2 further comprising a torque lever coupled to a transmission gear received at the housing and arranged to impart torque simultaneously to all magnet units in switching the device between on and off states.

4. Lifting device according to claim 1, wherein the fulcrums are located close to the engagement face in a common plane.

5. Lifting device according to claim 1, wherein the housing is box shaped, and wherein a lower side thereof provides the work face which is provided with exchangeable, wear-resistant pole shoe members

6. Lifting device according to claim 1, further comprising locating members provided at the housing which can be selectively moved between locking and an unlocked positions and which are spatially located such as to selectively fix, with or without play, the relative rotational positions of the clevis-shaped support members with respect to the housing in the first and second operational positions of the lifting device.
